(19) United States
(12) Patent Application Publication
(10) Pub. No.: US 2019/0065777 A1
(43) Pub. Date: Feb. 28, 2019

(54) APPROACH TO HIDE OR DISPLAY CONFIDENTIAL INCOMING MESSAGES AND/OR NOTIFICATIONS ON A USER INTERFACE

(71) Applicant: QUALCOMM Incorporated, San Diego, CA (US)

(72) Inventors: AnkammaRao RAVUVARI, Hyderabad (IN); Syam Pavan VADAPALLI, Visakhapatnam (IN); Srihari Venkata INAMPUDI, Hyderabad (IN)

(21) Appl. No.: 15/693,463

(22) Filed: Aug. 31, 2017

(51) Int. Cl. G06F 21/62; H04M 1/725; H04W 68/00; G06F 21/32; H04W 12/02

(52) U.S. Cl. CPC G06F 21/6245; H04M 1/72577; H04L 51/36; G06F 21/32; H04W 12/02; H04W 68/005

(57) ABSTRACT

The disclosure generally relates to an approach that can be used to hide and/or display incoming messages and/or related notifications on a user interface based on one or more factors related to confidentiality or sensitivity. More particularly, in response to a user equipment (UE) receiving an incoming message, the UE may determine whether the incoming message is secured or unsecured based at least in part on a sender identifier. The UE may display a notification regarding the incoming message on a user interface with the content of the incoming message hidden if the incoming message is secured. The UE may subsequently display the content of the incoming message on the user interface in response to receiving an authentic biometric input targeting the notification.

### TECHNICAL FIELD

The various aspects and embodiments described herein relate to an approach that can be used to hide and/or display incoming messages and/or related notifications on a user interface based on one or more factors related to confidentiality or sensitivity.

### BACKGROUND

In smartphones and other devices that display incoming message notifications (e.g., notifications about text messages, email messages, application-specific messages, etc.), current implementations tend to treat every incoming message the same. In particular, devices usually either display the complete message contents or completely hide the message contents depending on predefined, user-preferred, application-specific, and/or other appropriate settings. As such, current implementations tend to fall short in the sense that notifications regarding regular messages (e.g., messages that do not contain sensitive or otherwise private information) are not differentiated from notifications regarding messages from particular individuals, one-time-password (OTP) messages, password reset codes, notifications from financial institutions, or other messages that include information considered confidential, sensitive, private, etc.

That current implementations tend to hide or display the contents associated with all incoming messages can be quite inconvenient and/or insecure. For example, hiding all incoming messages indiscriminately can be inconvenient in the sense that the user is forced to unlock his/her device to read any incoming message, including those that do not contain sensitive information. On the other hand, displaying all incoming messages may expose sensitive information when the device is lost or unattended, or a user might simply want to read messages from certain senders in private.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

According to various aspects, a method for displaying incoming message notifications may comprise receiving an incoming message at a user equipment (UE), determining, at the UE, whether the incoming message is secured or unsecured based at least in part on a sender identifier, displaying, at the UE, a notification regarding the incoming message on a user interface (e.g., a lock screen), wherein the notification hides content of the incoming message in response to determining that the incoming message is secured, and displaying, at the UE, the content of the incoming message on the user interface in response to receiving an authentic biometric input targeting the notification (e.g., a user fingerprint focused on the notification in combination with a fingerprint recognition that matches an authorized user, a user gaze focused on the notification in combination with an iris recognition or a facial recognition that matches an authorized user, etc.). According to various aspects, the UE may determine that the incoming message is secured based at least in part on the sender identifier having a structure or format associated with an institutional sender, the sender identifier appearing in a user-defined secured sender list, the content of the incoming message including one or more sensitive terms, and/or other suitable criteria.

According to various aspects, an apparatus may comprise a display device, a receiver configured to receive an incoming message, and one or more processors configured to determine whether the incoming message is secured or unsecured based at least in part on a sender identifier, to display, via the display device, a notification regarding the incoming message on a user interface, wherein the notification is configured to hide content of the incoming message in response to a determination that the incoming message is secured, and to display, via the display device, the content of the incoming message on the user interface in response to an authentic biometric input targeting the notification.

According to various aspects, an apparatus may comprise means for receiving an incoming message, means for determining whether the incoming message is secured or unsecured based at least in part on a sender identifier, means for displaying a notification regarding the incoming message on a user interface, wherein the notification is configured to hide content of the incoming message in response to a determination that the incoming message is secured, and means for displaying the content of the incoming message on the user interface in response to an authentic biometric input targeting the notification.

According to various aspects, a computer-readable storage medium may store computer-executable instructions, which may be configured to cause a device having one or more processors to receive an incoming message, determine whether the incoming message is secured or unsecured based at least in part on a sender identifier, display a notification regarding the incoming message on a user interface, wherein the notification is configured to hide content of the incoming message in response to a determination that the incoming message is secured, and display the content of the incoming message on the user interface in response to an authentic biometric input targeting the notification.

Other objects and advantages associated with the aspects and embodiments disclosed herein will be apparent to those skilled in the art based on the accompanying drawings and detailed description.

### BRIEF DESCRIPTION OF THE DRAWINGS

A more complete appreciation of the various aspects and embodiments described herein and many attendant advantages thereof will be readily obtained as the same becomes better understood by reference to the following detailed description when considered in connection with the accompanying drawings which are presented solely for illustration and not limitation, and in which:

FIG. 1 illustrates a high-level architecture of a wireless communications system in which the various aspects and embodiments described herein may be practiced.

FIG. 2A and FIG. 2B illustrate example conventional approaches to hide or display incoming message notifications on a user interface, such as a lock screen.

FIG. 3 illustrates an exemplary approach to hide or display incoming message notifications on a user interface in accordance with various aspects and embodiments.

FIG. 4 illustrates an exemplary method to hide or display incoming message notifications on a user interface, according to various aspects.

FIG. 5 illustrates an exemplary method to categorize an incoming message notification as secured or unsecured such that the incoming message notification may be appropriately hidden or displayed on a user interface, according to various aspects.

FIG. 6 illustrates exemplary UEs that may have a user interface configured to display confidential incoming messages and/or notifications in accordance with the various aspects and embodiments described herein.

FIG. 7 illustrates an exemplary mobile device that may have a user interface configured to display confidential incoming messages and/or notifications in accordance with the various aspects and embodiments described herein.

FIG. 8 illustrates an exemplary wireless device that may have a user interface configured to display confidential incoming messages and/or notifications in accordance with the various aspects and embodiments described herein.

FIG. 9 illustrates an exemplary wearable device that may have a user interface configured to display confidential incoming messages and/or notifications in accordance with the various aspects and embodiments described herein.

FIG. 10 illustrates an exemplary computing device that may have a user interface configured to display confidential incoming messages and/or notifications in accordance with the various aspects and embodiments described herein.

### DETAILED DESCRIPTION

Various aspects and embodiments are disclosed in the following description and related drawings to show specific examples relating to exemplary aspects and embodiments. Alternate aspects and embodiments will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and embodiments disclosed herein.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage, or mode of operation.

The terminology used herein describes particular embodiments only and should not be construed to limit any embodiments disclosed herein. As used herein, the singular forms “a,” “an,” and “the” are intended to include the plural forms as well, unless the context clearly indicates otherwise. Those skilled in the art will further understand that the terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Further, various aspects and/or embodiments may be described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequences of actions described herein can be considered to be embodied entirely within any form of non-transitory computer-readable medium having stored thereon a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to” and/or other structural components configured to perform the described action.

The techniques described herein may be used in connection with various wireless communication systems such as CDMA, TDMA, FDMA, OFDMA, and SC-FDMA systems. The terms “system” and “network” are often used interchangeably. A CDMA system may implement a radio technology such as Universal Terrestrial Radio Access (UTRA), CDMA2000, etc. UTRA includes Wideband CDMA (WCDMA) and other variants of CDMA. CDMA2000 covers IS-2000, IS-95, and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink UTRA, E-UTRA, UMTS, LTE, and GSM are described in documents from the “3rd Generation Partnership Project” (3GPP). CDMA2000 and UMB are described in documents from an organization named “3rd Generation Partnership Project 2” (3GPP2). For clarity, certain aspects are described below for LTE, and LTE terminology may be used in much of the description below.

As used herein, the terms “user device,” “user equipment” (or “UE”), “user terminal,” “client device,” “communication device,” “wireless device,” “wireless communications device,” “handheld device,” “mobile device,” “mobile terminal,” “mobile station,” “handset,” “access terminal,” “subscriber device,” “subscriber terminal,” “subscriber station,” “terminal,” and variants thereof may interchangeably refer to any suitable mobile or stationary device. Accordingly, the above-mentioned terms may suitably refer to any one or all of cellular telephones, smart phones, personal or mobile multimedia players, personal data assistants, laptop computers, personal computers, tablet computers, smart books, palm-top computers, wireless electronic mail receivers, multimedia Internet-enabled cellular telephones, wireless gaming controllers, and similar devices with a programmable processor, memory, and circuitry to connect to and communicate over a radio access network (RAN) that implements a particular radio access technology (RAT), over a wired network, over a wireless local area network (WLAN) (e.g., based on IEEE 802.11, etc.), and/or with other devices via a direct device-to-device (D2D) or peer-to-peer (P2P) connection.

According to various aspects, a communication link through which one or more UEs can send signals to the RAN, the wired network, the WLAN, etc. is called an uplink or reverse link channel (e.g., a reverse traffic channel, a reverse control channel, an access channel, etc.), while a communication link through which the RAN, the wired network, the WLAN, etc. can send signals to UEs is called a downlink or forward link channel (e.g., a paging channel, a control channel, a broadcast channel, a forward traffic channel, etc.). As used herein the term traffic channel (TCH) can refer to either an uplink/reverse link channel or a downlink/forward link channel.

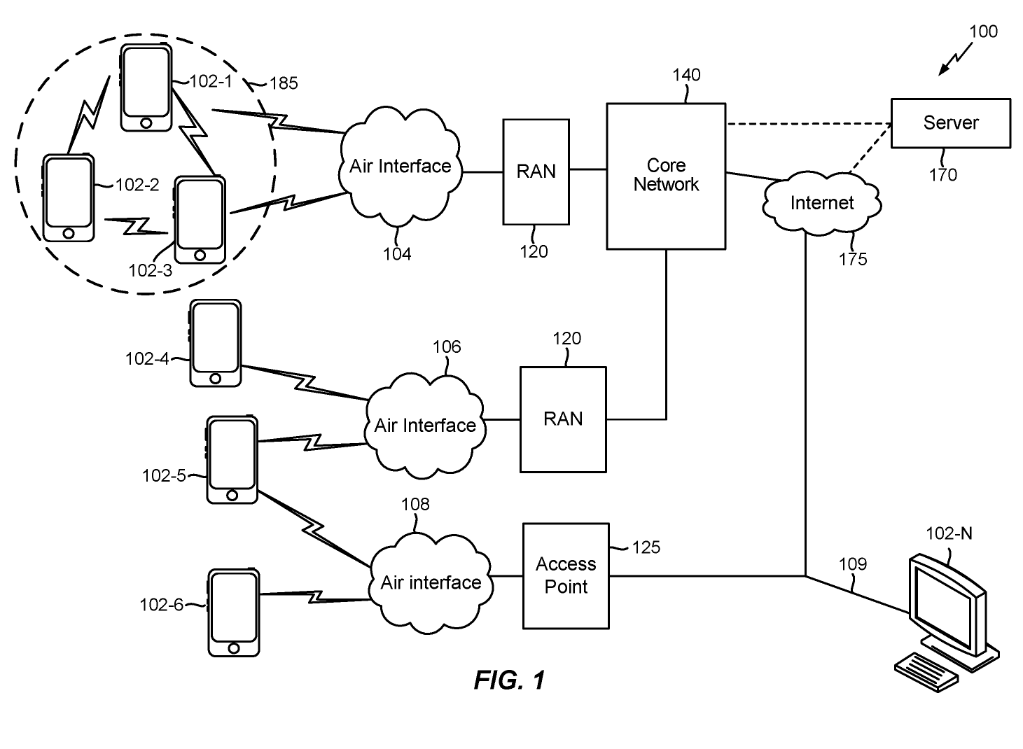

According to various aspects, FIG. 1 illustrates a high-level system architecture of a wireless communications system 100 that may support voice-based multimedia services. In various embodiments, the wireless communications system 100 may contain various UEs, including UE 102-1, UE 102-2, UE 102-3, UE 102-4, UE 102-5, 102-6, UE 102-N, collectively referred to herein as UEs 102-1 . . . N. The UEs 102-1 . . . N can include cellular telephones, smart phones, personal or mobile multimedia players, personal data assistants, laptop computers, personal computers, tablet computers, and so on. For example, in FIG. 1, UE 102-1 . . . 6 are illustrated as cellular touchscreen phones or smart phones and UE 102-N is illustrated as a desktop computer.

Referring to FIG. 1, the UEs 102-1 . . . N may communicate with an access network (e.g., a RAN 120, an access point 125, etc.) over a physical communications interface or layer, shown in FIG. 1 as air interfaces 104, 106, 108 and/or a direct or indirect wired connection 109. The air interfaces 104 and 106 can comply with a given cellular communications protocol (e.g., CDMA, EV-DO, eHRPD, GSM, EDGE, W-CDMA, LTE, etc.), while the air interface 108 can comply with a wireless local area network (WLAN) protocol (e.g., IEEE 802.11). Although not explicitly shown in FIG. 1, the RAN 120 may include various access points that can serve UEs over air interfaces, such as the air interfaces 104 and 106. Each access point in the RAN 120 can be referred to as an access node or AN, an access point or AP, a base station or BS, a Node B, an evolved Node B, an eNodeB or eNB, and so on. These access points can be terrestrial access points (or ground stations) or satellite access points. The RAN 120 may be configured to connect to a core network 140 that can perform various functions, including bridging calls (e.g., voice calls) between UEs serviced via the RAN 120 and other UEs serviced via the RAN 120 or an altogether different RAN.

In various embodiments, the RAN 120 may be configured to bridge circuit-switched (CS) calls between UEs serviced via the RAN 120 and other UEs serviced via the RAN 120 or an altogether different RAN. In various embodiments, the RAN 120 may also be configured to mediate an exchange of packet-switched (PS) data with external networks such as Internet 175. The Internet 175 may generally include various routing agents and processing agents (not explicitly shown in FIG. 1 for sake of convenience). In FIG. 1, UE 102-N is shown as connecting to the Internet 175 via the wired connection 109 (i.e., separate from the core network 140, such as over an Ethernet connection to an 802.11-based wireless local area network). The Internet 175 can thereby bridge packet-switched data communications (including data associated with voice calls) between UE 102-N and UEs 102-1 to 102-6 via the core network 140. Also shown in FIG. 1 is the access point 125 separate from the RAN 120. The access point 125 may connect to the Internet 175 independently from the core network 140 (e.g., via an optical communication system, a cable modem, etc.). The air interface 108 may serve UE 102-5 or UE 102-6 over a local wireless connection, such as IEEE 802.11 in an example. UE 102-N is shown as a desktop computer with the wired connection 109 to the Internet 175, such as a direct connection to a modem or router, which can correspond to the access point 125 itself in one example (e.g., a WLAN router with wired and/or wireless connectivity may correspond to the access point 125).

Referring to FIG. 1, UEs 102-1, 102-2, and 102-3 are depicted as part of a D2D network or D2D group 185, with UEs 102-1 and 102-3 being connected to the RAN 120 via the air interface 104. In an embodiment, UE 102-2 may also gain indirect access to the RAN 120 via mediation by UEs 102-1 and/or 102-3, whereby data ‘hops’ to/from UE 102-2 and one (or more) of UEs 102-1 and 102-3, which may communicate with the RAN 120 on behalf of UE 102-2.

Referring to FIG. 1, a server 170 is shown as connected to the Internet 175, the core network 140, or both. The server 170 can be implemented as multiple structurally separate servers or alternately as a single server. The server 170 may correspond to any suitable type of server, such as a web server (e.g., hosting a web page), an application download server, or an application server configured to support one or more communication services for UEs that can connect to the server 170 via the core network 140 and/or the Internet 175 (e.g., Voice-over-Internet Protocol (VoIP) sessions, Voice-over-LTE (VoLTE) sessions, Push-to-Talk (PTT) sessions, group communication sessions, sessions that involve Video-over-LTE (ViLTE) or other suitable video call services, Rich Communication Services (RCS), social networking services, etc.).

According to various aspects, the UEs 102-1 . . . N as shown in FIG. 1 may be configured to communicate and to send and/or receive messages within the wireless communications system 100 (e.g., Short Message Service (SMS) messages, Multimedia Message Service (MMS) messages, email messages, application-specific messages, etc.). In various circumstances, however, one or more of the UEs 102-1 . . . N may enter a locked state or other suitable state in which certain functionality is disabled in order to save power, prevent unauthorized or unintended use or access, or for other suitable reasons. In general, as would be apparent to those skilled in the art, a locked device may display a lock screen to indicate the locked state and the user may be required to input an unlock command, such as a password, an identifiable unlock gesture, a biometric input, etc. in order to use the locked device. However, the user may want to receive notifications without having to unlock the device to be informed about incoming messages that are received while the device is locked.

As such, one or more of the UEs 102-1 . . . N may have capabilities to display incoming message notifications on a user interface. In smartphones and other devices that display incoming message notifications (e.g., notifications about text messages, email messages, application-specific messages, etc.), current implementations tend to treat every incoming message the same. In particular, devices usually either display the complete message contents or completely hide the message contents depending on predefined, user-preferred, application-specific, and/or other appropriate settings. As such, current implementations tend to fall short in the sense that notifications regarding regular messages (e.g., messages that do not contain sensitive or otherwise private information) are not differentiated from notifications regarding messages from particular individuals, one-time-password (OTP) messages, password reset codes, notifications from financial institutions, or other messages that include information considered confidential, sensitive, private, etc.

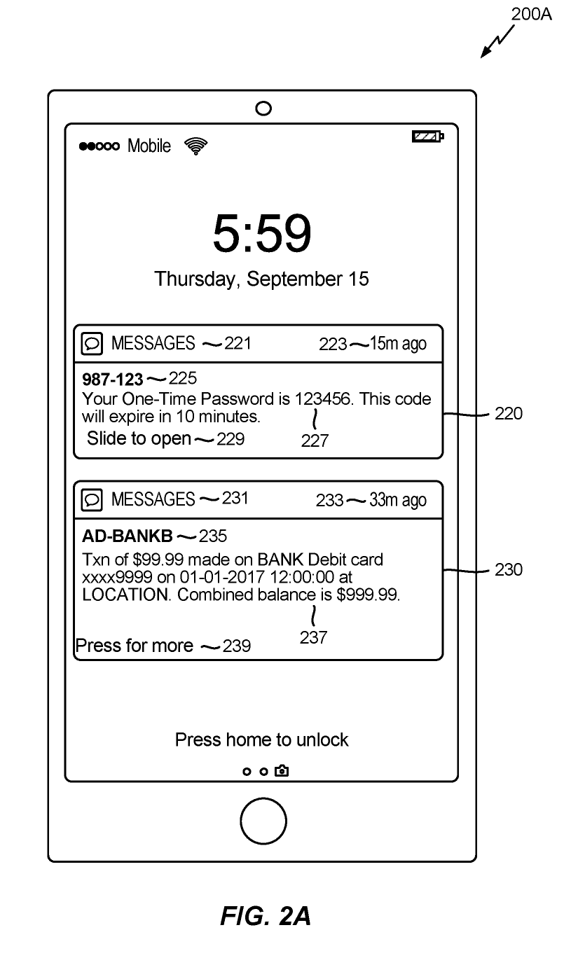

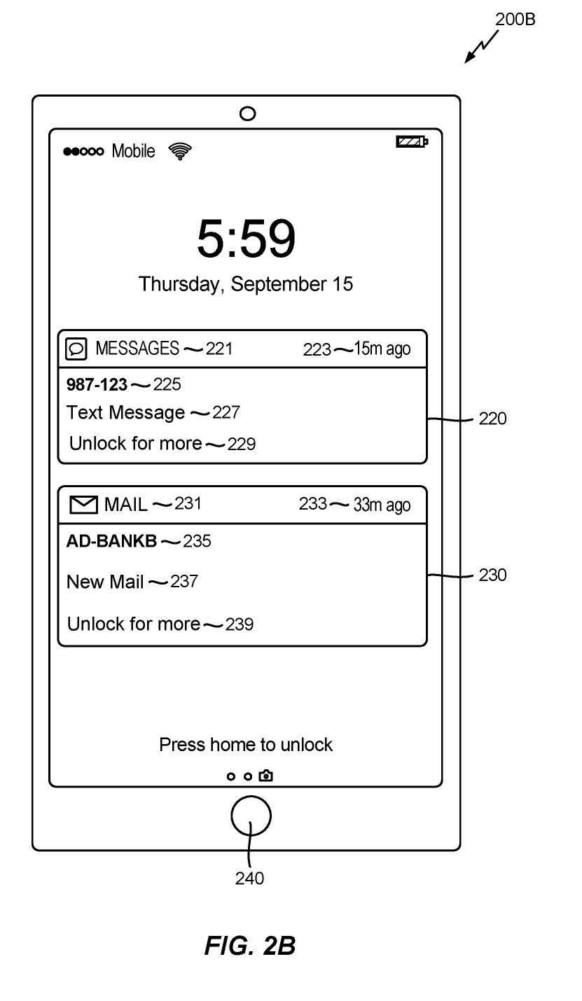

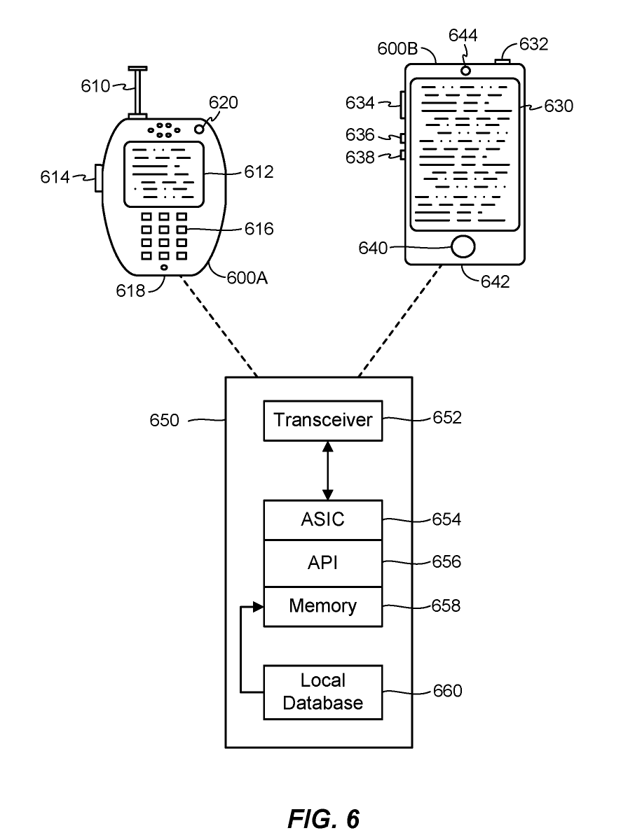

More particularly, according to various aspects, FIG. 2A and FIG. 2B illustrate example conventional approaches to hide or display incoming message notifications on a user interface, such as a lock screen. For example, FIG. 2A illustrates an exemplary lock screen user interface 200A in which the entire contents associated with all incoming messages are displayed indiscriminately, while FIG. 2B illustrates an exemplary lock screen user interface 200B employing the opposite approach, hiding the contents associated with all incoming messages indiscriminately. Although the lock screen user interfaces 200A, 200B shown in FIG. 2A and FIG. 2B have the appearance of a smartphone, those skilled in the art will appreciate that the same approaches may be used in any suitable electronic device that can display notifications regarding incoming messages, including tablets, laptops, wearable devices, mobile devices, and so on (e.g., electronic devices having a configuration as shown in any one or more of FIG. 6-10).

According to various aspects, the lock screen user interfaces 200A, 200B as shown in FIG. 2A and FIG. 2B may be displayed to convey that the device is in a locked state in which certain functionalities associated with the device are disabled. For example, as would be apparent to those skilled in the art, the device may be locked when the device has been idle for a threshold time period, when the display has been shut off and is subsequently turned on, when the device is first booted, when a user has logged off or is switching between users, as a power saving measure, or other similar circumstances in which disabling functionality of the device may be desired. The functionality may be disabled as a security measure to prevent unauthorized access, or may be disabled in order to ignore certain user inputs when user inputs are not expected, such as when the user has logged off, placed the device into his/her pocket, etc. Unlocking the device from the lock screen user interfaces 200A, 200B may return the device to an unlocked state without disabled functionality. The device may return to a state the device was in before the locked state, or the device may return to a home screen or other default state, enter an application that was selected from the lock screen user interfaces 200A, 200B, etc. In various embodiments, the device may be unlocked in association with one or more security settings, and may therefore require a suitable authentication input. For example, the authentication input may comprise a user password or passphrase, a specific gesture or input command, a biometric input, and/or other suitable inputs that can be used to validate the identity of the user attempting to unlock the device.

According to various aspects, as mentioned above, one or more notifications may be displayed on the lock screen user interfaces 200A, 200B to indicate that one or more incoming messages have been received. For example, referring to FIG. 2A, the lock screen user interface 200A includes a first notification 220 that includes an application-specific identifier 221 to indicate an application that received an incoming message, a timestamp 223 to indicate when the incoming message was received, a sender identifier 225 to indicate the user/entity that originated the message, contents 227 associated with the incoming message, and an action prompt 229 to indicate an action that can be taken to view the message. In a similar respect, a second notification 230 also includes an application-specific identifier 231 to indicate an application that received an incoming message, a timestamp 233 to indicate when the incoming message was received, a sender identifier 235 to indicate the user/entity that originated the message, contents 237 associated with the incoming message, and an action prompt 239 to indicate an action that can be taken to view the message.

As mentioned above, FIG. 2A illustrates the conventional approach that displays the entire contents associated with all incoming messages indiscriminately, even though the contents 227 and the contents 237 include potentially confidential or otherwise sensitive information. For example, as illustrated in FIG. 2A, the first notification 220 pertains to a one-time password message and the second notification 230 pertains to a message about a financial transaction. In both cases, the contents 227, 237 include information that a user may wish to protect against unintended or unauthorized exposure, whereby the approach shown in FIG. 2A may generally be considered insecure at least with respect to notifications about incoming messages with contents that the user may wish to keep confidential or private. In FIG. 2B, the opposite approach is taken, whereby the message contents 227, 237 are entirely hidden and the user can only see the application-specific identifiers 221, 231, the timestamps 223, 233, the sender identifiers 225, 235, and the action prompts 229, 239. Although the approach shown in FIG. 2B may protect confidential, sensitive, or otherwise private information from exposure, the approach taken in FIG. 2B also has some inconveniences. For example, even though some messages may be innocuous or otherwise contain content that the user would prefer to be visible on the lock screen user interface 200B, the user must instead unlock the device, such as by pressing a home button 240 along with providing a password or biometric input, in order to view the hidden message contents.

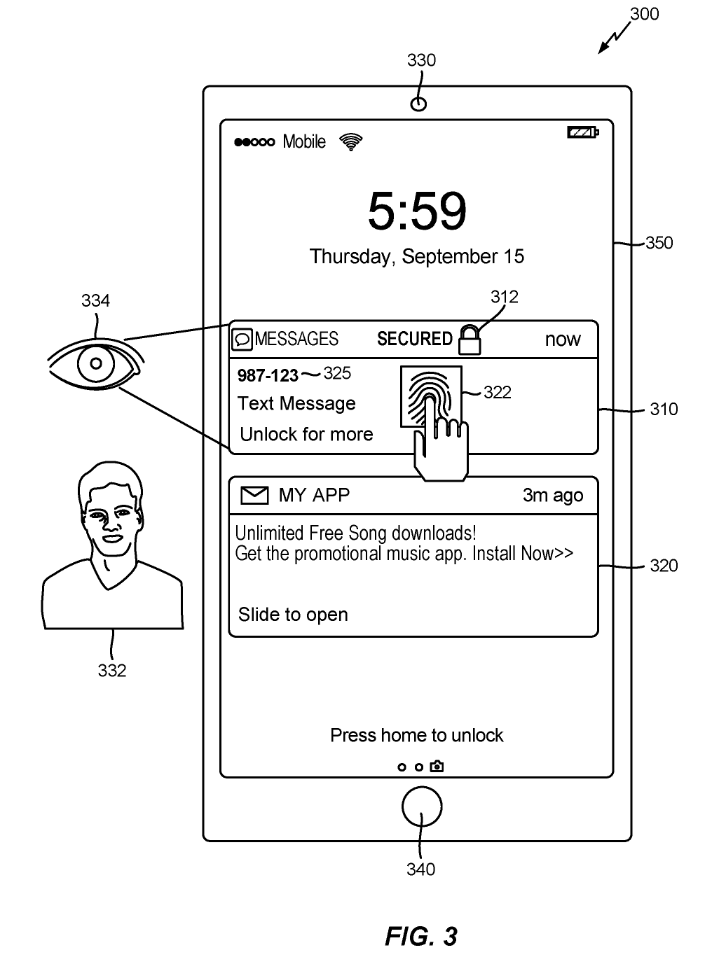

Accordingly, FIG. 3 illustrates an exemplary approach to hide or display incoming message notifications on a user interface 300 in a manner that may address these and other drawbacks of existing approaches that tend to indiscriminately hide or display the contents of incoming message notifications. More particularly, as will be described in further detail herein, the approach illustrated in FIG. 3 may consider one or more factors related to confidentiality or sensitivity to determine whether a particular incoming message is to be considered secured or unsecured, wherein the contents of secured messages may be hidden while the contents of unsecured messages may be displayed. In various embodiments, messages from banks, organizations, companies, and/or other institutional senders that include a one-time-password (OTP), a password reset code, financial details, and so on are often associated with sender identifiers that have a particular structure or format distinct from messages that originate from other users. For example, in FIG. 3, a first notification 310 shown on the user interface is associated with a sender identifier 325 in which a sequence of digits is structured differently from a telephone number, contact name, or other identifier that is typically associated with a user. As such, based on the format of the sender identifier 325, the first notification 310 may be categorized as secured, as depicted at 312, and the contents of the message are hidden from display. In a further alternative and/or additional aspect, the contents of the message may be considered, wherein an incoming message may be categorized as secured or unsecured depending on whether terms such as “password,” “passcode,” “balance,” and so on are present. Alternatively and/or additionally, the user may be given the option to define a secured senders list, which may include one or more specific users, senders, groups of users/senders, etc., whereby any messages received from a sender that appears in the secured senders list may be automatically categorized as secure regardless of the structure/format of the sender identifier and/or the contents of the incoming message. The user may also be given the option to define an unsecured senders list, whereby any messages received from a sender in the unsecured senders list may be automatically categorized as unsecured regardless of the structure/format of the sender identifier and/or the contents of the incoming message. As such, whereas the first notification 310 hides the underlying contents of the message (e.g., based on the sender identifier 325, keywords in the hidden contents, etc.), FIG. 3 illustrates a second notification 320 where the contents of an unsecured message are displayed.

According to various aspects, the approach shown in FIG. 3 may also provide the user with the ability to view the hidden contents of the first notification 310 without unlocking the device. More particularly, in various embodiments, the approach shown in FIG. 3 may assume that the device shown therein has capabilities to receive a biometric input focused on or otherwise targeting a specific area on the user interface 300. For example, an increasingly common capability in modern electronic devices is to provide a home button 340 having a fingerprint sensor included or otherwise integrated therein (e.g., a sensor that uses capacitive touch to pass a small current through a user fingertip and thereby create a high-resolution map of the user's fingerprint). However, the fingerprint sensor integrated into the home button 340 does not allow the user to convey an intent to view the hidden contents associated with a particular notification (e.g., the first notification 310).

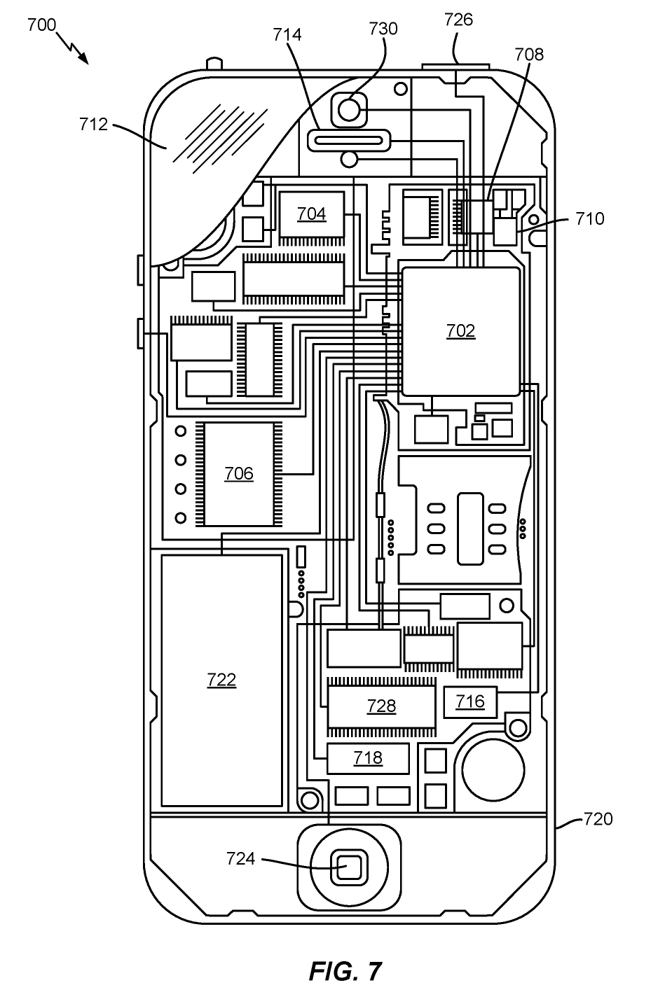

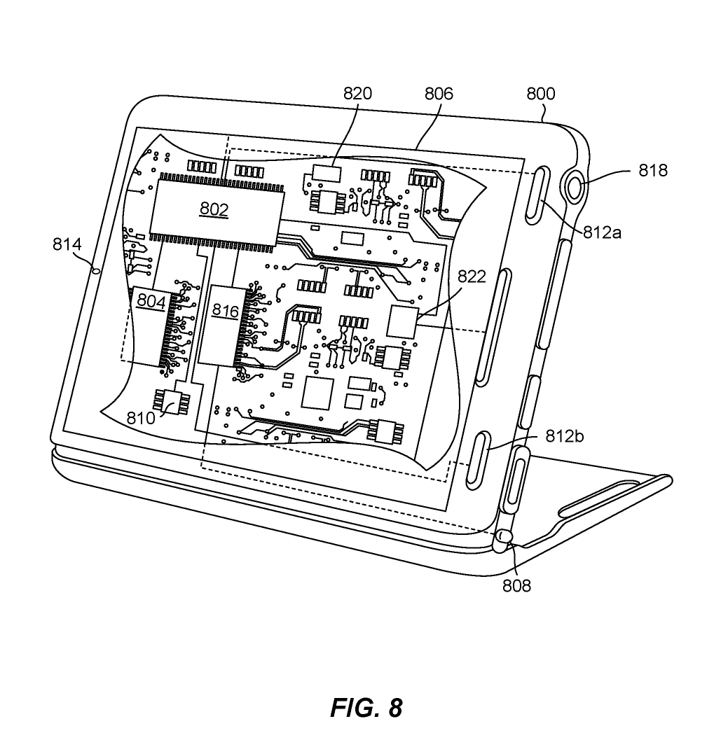

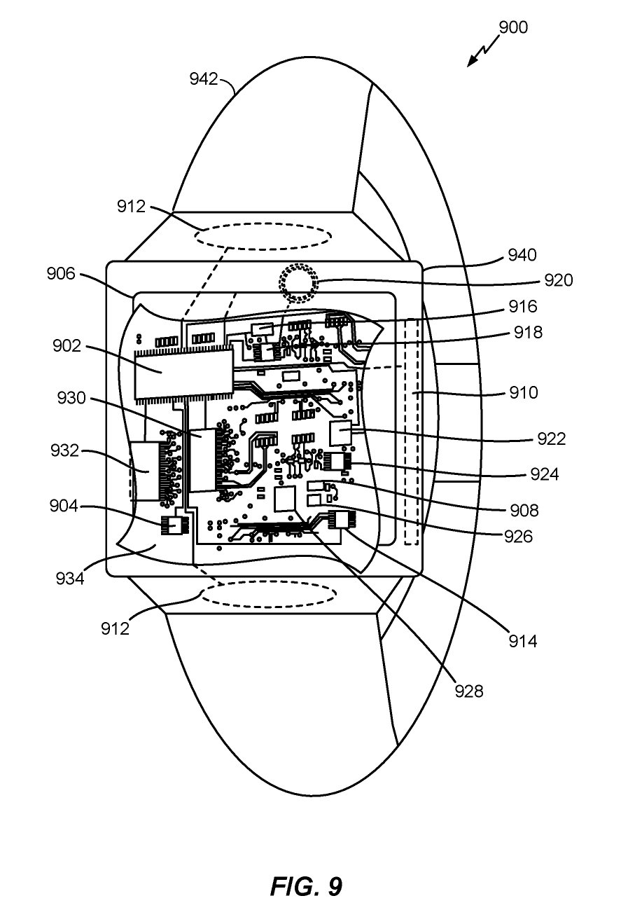

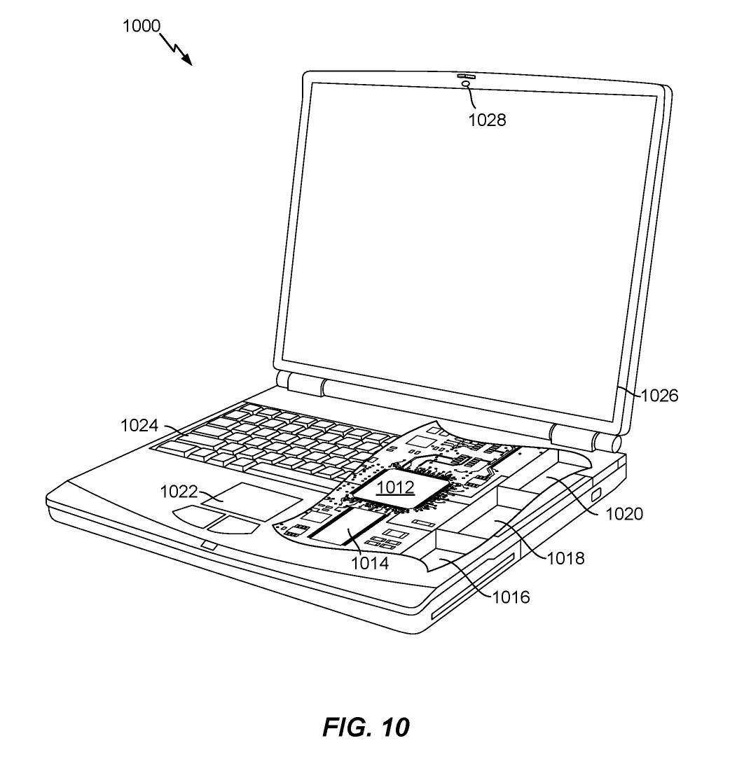

Accordingly, the various aspects and embodiments described herein contemplate that the user interface 300 shown in FIG. 3 may be displayed on any suitable device that has the capability to detect a biometric input that targets or focuses on a specific area within the user interface 300 (e.g., a device that has a hardware configuration as shown in FIG. 6, FIG. 7, FIG. 8, FIG. 9, and/or FIG. 10). More particularly, in one use case, the device may include a touchscreen display 350 that has hardware capabilities to read a fingerprint at any suitable location on the touchscreen display 350. For example, the touchscreen display 350 may include one or more sensing infrared diodes that can sense visible or invisible light that is emitted from a source light and reflected off of the surface of a target object, such as a fingerprint on a finger pressed against the touchscreen display 350. As such, the sensed light can be used to determine a surface profile of the fingerprint based on how patterned infrared light reflects off of grooves in the fingerprint surface, thus indicating the unique surface pattern of the fingerprint. As such, when an authentic user fingerprint is detected on the first notification 310, as depicted at 322, the hidden message contents may be displayed on the user interface 300 without the user having to unlock the device. Furthermore, those skilled in the art will appreciate that any other suitable biometric other than and/or in addition to a fingerprint may be used. For example, assuming that the device has the ability to perform face recognition and/or iris recognition based on an image 332 captured using a front-facing camera 330, the face recognition and/or iris recognition can be used in combination with gaze tracking to determine that the user is looking at the first notification 310, as depicted at 334.

In any case, the various aspects and embodiments described herein contemplate that the device has one or more capabilities to capture a biometric input to verify the identity of an authorized user and capabilities to determine a specific point or area of focus for the captured biometric input. As such, when an authentic biometric input is received and the authentic biometric input targets or otherwise focuses on a notification about a secured message, as depicted at 322 and 334, the hidden contents may be displayed on the user interface 300 without requiring the user to first unlock the device.

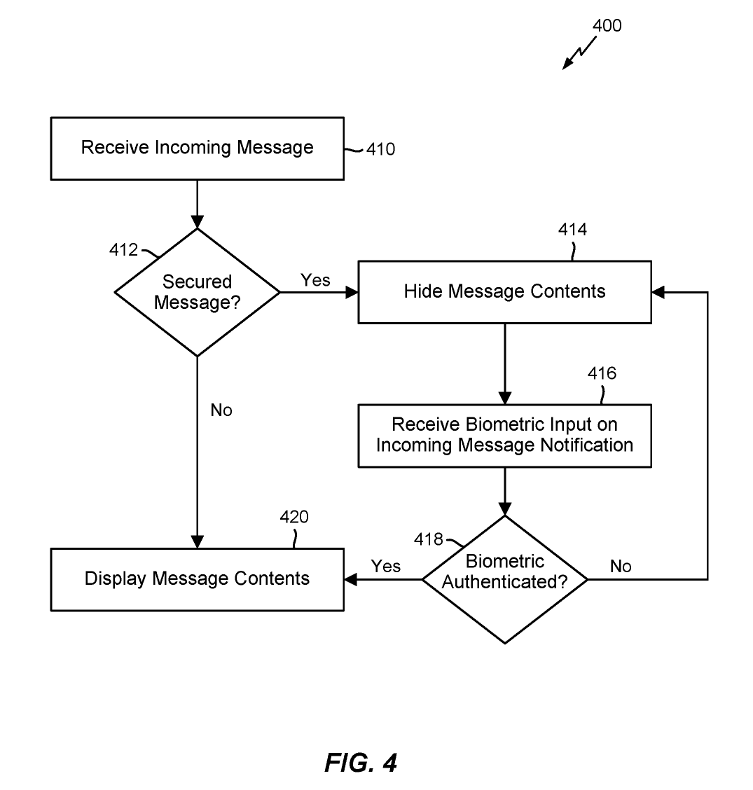

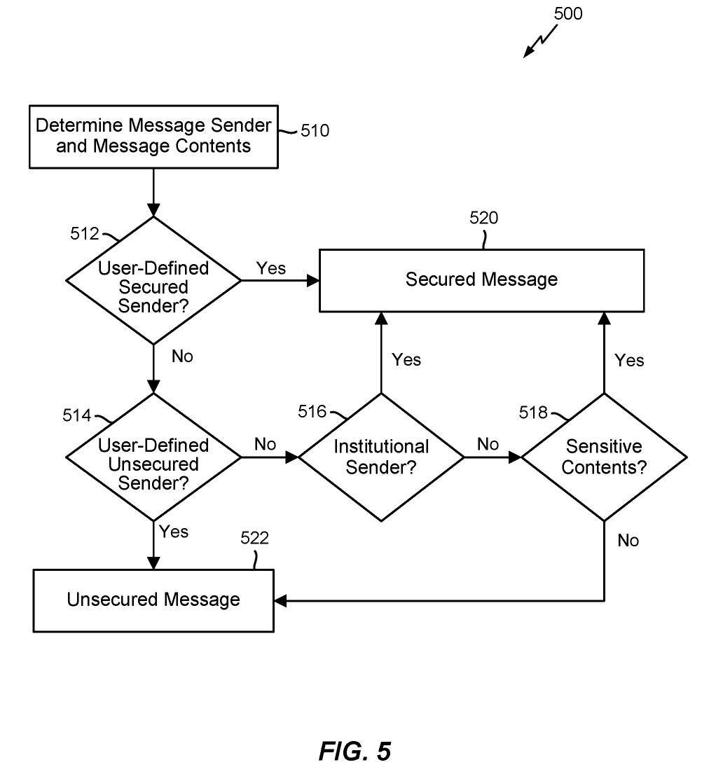

According to various aspects, the approach described above to hide or display incoming message notifications on a user interface will now be described with reference to the methods 400, 500 shown in FIG. 4 and FIG. 5. In general, the methods 400, 500 shown in FIG. 4 and FIG. 5 may be implemented on any suitable user equipment (UE) that has appropriate capabilities to display notifications related to incoming messages on a user interface and to capture biometric input(s) targeted or otherwise focused on a specific point or area of the user interface. For example, in various embodiments, the methods 400, 500 illustrated in FIG. 4 and FIG. 5 may be implemented on a UE that has a hardware configuration as shown in FIG. 6, FIG. 7, FIG. 8, FIG. 9, and/or FIG. 10. However, those skilled in the art will appreciate that the hardware configurations shown therein are exemplary only, as the methods 400, 500 may be implemented on UEs having other suitable hardware configurations in addition to those described herein.

More particularly, referring to FIG. 4, the UE may receive an incoming message at block 410, wherein the incoming message may be received while the UE is in a locked state (e.g., while displaying a lock screen, while the display is turned off or the device is in a sleep state, etc.). In various embodiments, at block 412, the UE may then determine whether the incoming message is a secured message or an unsecured message. For example, referring to FIG. 5, the method 500 illustrated therein may provide one approach to categorize the incoming message as secured or unsecured based on the identity of the sender and/or the contents of the incoming message, as determined at block 510. In various embodiments, as mentioned above, a user may be given an option to define a secured senders list, which may include one or more specific users, senders, groups of users/senders, etc. from which any incoming messages are to be automatically categorized as secured. The user may also be given the option to define an unsecured safe senders list, wherein any incoming messages received from a sender in the unsecured senders list may be automatically categorized as unsecured. Accordingly, as shown in FIG. 5, the UE may determine whether the sender of the incoming message appears in the secure sender list at block 512, in which case the incoming message may be categorized as secure at block 520. Alternatively, in response to determining that the sender of the incoming message does not appear in the secure sender list, the UE may further determine whether the sender of the incoming message appears in the unsecured sender list at block 514, in which case the incoming message may be categorized as unsecured at block 522. However, in various circumstances, the sender of the incoming message may not exist in the secured sender list or the unsecured sender list. In such cases, the UE may consider additional criteria to determine whether the incoming message should be considered secured or unsecured.

For example, as depicted at block 516, the UE may determine whether the incoming message was received from an institutional sender, such as a bank, a website, a service provider, etc. In many cases, messages from institutional senders such as banks, websites, service providers, etc. are associated with sender identifiers that have a particular structure or format that is distinct from messages that originate from other users (e.g., an alphanumeric string, a sequence of digits, etc. having a different structure than a telephone number or other identifier typically employed to identify a user). Accordingly, the UE may categorize the incoming message as secured at block 520 in response to a determination at block 516 that the sender is an institutional sender based on the structure and/or format of the sender identifier. Alternatively and/or additionally, the incoming message may be categorized as secured at block 520 in response to determining that the incoming message has sensitive contents at block 518. For example, the incoming message may be determined to have sensitive contents when the message includes one or more terms such as “password,” “passcode,” “balance,” etc., wherein those skilled in the art will appreciate that these terms are not exhaustive and that many other words, phrases, or combinations thereof may indicate an incoming message having sensitive contents. Furthermore, in one alternative and/or additional aspect, the user may be given the option to define one or more words, phrases, etc. that indicate sensitive contents and vice versa (i.e., words, phrases, etc. to exclude when considering whether the incoming message has sensitive contents). Referring to FIG. 5, the incoming message may therefore be categorized as secured at block 520 when the incoming message is determined to have been received from an institutional sender and/or determined to have sensitive contents. Alternatively, the incoming message may be categorized as unsecured at block 522 when received from a non-institutional sender and the contents do not appear to be sensitive.

According to various aspects, referring again to FIG. 4, a notification regarding the incoming message may be displayed on the user interface (e.g., the lock screen), wherein the notification may display the contents of the incoming message at block 420 in response to determining that the incoming message is unsecured (e.g., as determined via the method 500 shown in FIG. 5). However, in response to a determination that the incoming message is secured, the notification may hide the contents of the incoming message at block 414. In various embodiments, as depicted at block 416, the UE may receive a biometric input on the notification regarding the incoming message. For example, the UE may include a touchscreen display that has hardware capabilities to read a fingerprint at any suitable location on the touchscreen display 350, capabilities to perform gaze tracking in combination with face recognition and/or iris recognition (e.g., based on an image captured using a front-facing camera, input data received via virtual reality or augmented reality glasses or other suitable wearable devices, etc.). In any case, assuming the capability to detect a biometric input specifically targeting or otherwise focused on the notification about the incoming message, at block 418, the UE may determine whether the biometric input is authentic (i.e., matches a biometric associated with an authorized user). In response to a determination that the biometric input is authentic, the hidden contents of the incoming message may be suitably displayed on the user interface at block 420 (e.g., on the lock screen and without unlocking the device). However, in response to determining that the biometric input does not match a biometric associated with an authorized user, the contents of the incoming message may continue to be hidden at block 414.

According to various aspects, FIG. 6 illustrates exemplary wireless devices 600A, 600B that may have a user interface configured to hide or display incoming messages and/or message notifications in accordance with the various aspects and embodiments described herein. In the example embodiments shown in FIG. 6, the wireless device 600A is illustrated as a telephone and the wireless device 600B is illustrated as a touchscreen device (e.g., a smart phone, a tablet computer, etc.). As shown in FIG. 6, an external casing of the wireless device 600A may be configured with an antenna 610, a display 612, at least one button 614 (e.g., a power button, a volume control button, etc.), a keypad 616, a microphone 618, and a screen-facing camera 620. Furthermore, as shown in FIG. 6, the wireless device 600B may include an external casing configured with a touchscreen display 630, peripheral buttons 632, 634, 636, and 638 (e.g., a power control button, a volume or vibrate control button, an airplane mode toggle button, etc.), at least one front-panel button 640 (e.g., a Home button, etc.), a microphone 642, and a screen-facing camera 644. In various embodiments, the button 614 and/or other peripheral buttons 632, 634, 636 and 638 may be used to open direct communication to a target device. However, those skilled in the art will appreciate that other devices and methods can be alternately used to engage in communication, such as a “soft key” on touchscreen display 630, other methods as known in the art. Furthermore, those skilled in the art will appreciate that the wireless device 600A may include various other components that may not be separately illustrated in FIG. 6 or described herein (e.g., a rear-facing camera, speakers, etc.).

In various embodiments, while not shown explicitly in FIG. 6, the wireless device 600B can include one or more external antennas and/or one or more integrated antennas that are built into the external casing of the wireless device 600B, including but not limited to wireless local area network (WLAN) antennas, cellular antennas, satellite position system (SPS) antennas (e.g., global positioning system (GPS) antennas), and so on, and the wireless device 600A may likewise include one or more external and/or integrated antennas in addition to the antenna 610. In any case, the one or more external and/or integrated antennas (including at least the antenna 610) can be used to open a direct communication channel with the wireless devices 600A and/or 600B and thereby provide a direct communication interface to the wireless devices 600A and/or 600B, wherein the direct communication interface may typically comprise hardware known to those skilled in the art. Furthermore, in various embodiments, the direct communication interface can integrate with standard communication interfaces associated with the wireless devices 600A and/or 600B that are ordinarily used to carry video, audio, and other data to and from the wireless devices 600A and/or 600B.

Furthermore, although internal components of the wireless device 600A and the wireless device 600B can be embodied with different hardware configurations, FIG. 6 shows one exemplary platform 650 that may provide a basic high-level configuration for internal hardware components associated with the wireless devices 600A and/or 600B. In particular, the platform 650 can generally receive and execute software applications, data, and/or commands transmitted from a cellular network that may ultimately come from a core network, the Internet, and/or other remote servers and networks (e.g., an application server, web URLs, etc.). The platform 650 can also independently execute locally stored applications without cellular network interaction. The platform 650 can include a transceiver 652 coupled to an application specific integrated circuit (ASIC) 654, or other processor, microprocessor, logic circuit, or other data processing device. The ASIC 654 or other processor executes an application programming interface (API) 656 layer that interfaces with any application environment resident in a memory 658, which can include the operating system loaded on the ASIC 654 and/or any other resident programs in the memory 658 (e.g., the “binary runtime environment for wireless” (BREW) wireless device software platform developed by QUALCOMM®). The memory 658 can be comprised of read-only memory (ROM) or random-access memory (RAM), electrically erasable programmable ROM (EEPROM), flash cards, or any memory common to computer platforms. The platform 650 also can include a local database 660 that can store applications not actively used in memory 658, as well as other data. The local database 660 is typically a flash memory cell, but can be any secondary storage device as known in the art, such as magnetic media, EEPROM, optical media, tape, soft or hard disk, or the like.

According to various aspects, the functionality described herein to hide or display incoming messages and/or notifications on a user interface as described herein can be implemented on the wireless devices 600A, 600B shown in FIG. 6 and/or other suitable devices with similar external and/or internal components. For example, as will be apparent to those skilled in the art, the various functional features described herein can be embodied in discrete elements, software modules executed on a processor, and/or any combination of software and hardware to achieve the functionality described herein. For example, the ASIC 654, the memory 658, the API 656, and the local database 660 may all be used cooperatively to load, store and execute any software used to implement the approach to hide or display incoming messages and/or notifications on a user interface as described herein and perform the various associated functions described herein, whereby the logic to perform such functions may be distributed over various elements. Alternatively, the functionality could be incorporated into one discrete component. Furthermore, certain wireless devices that may be used in the various embodiments disclosed herein may not include certain components and/or functionalities associated with the wireless devices 600A and 600B shown in FIG. 6. Therefore, those skilled in the art will appreciate that the features associated with the wireless devices 600A and 600B shown in FIG. 6 are merely illustrative and the disclosure is not limited to the illustrated features or arrangements.

According to various aspects, the wireless devices 600A, 600B can be based on different technologies, including, without limitation, CDMA, W-CDMA, time division multiple access (TDMA), frequency division multiple access (FDMA), Orthogonal Frequency Division Multiplexing (OFDM), GSM, or other protocols that may be used in a wireless communications network or a data communications network. As discussed in the foregoing and known in the art, voice transmission and/or data can be transmitted to the wireless devices 600A and/or 600B from and using various networks and network configurations. Accordingly, the illustrations provided herein are not intended to limit the aspects of the disclosure and are merely to aid in the description of various aspects disclosed herein.

According to various aspects, FIG. 7 illustrates an exemplary mobile device 700 that may have a user interface configured to hide or display incoming messages and/or notifications in accordance with the various aspects and embodiments described herein. In various embodiments, the mobile device 700 may include a processor 702 coupled to a touchscreen controller 704 and an internal memory 706. The processor 702 may be one or more multi-core integrated circuits designated for general or specific processing tasks. The internal memory 706 may be volatile or non-volatile memory, and may also be secure and/or encrypted memory, or unsecure and/or unencrypted memory, or any combination thereof. The touchscreen controller 704 and the processor 702 may also be coupled to a touchscreen panel 712, such as a resistive-sensing touchscreen, capacitive-sensing touchscreen, infrared sensing touchscreen, etc. Additionally, a display of the mobile device need not have touchscreen capabilities.

The mobile device 700 may have one or more cellular network transceivers 708 coupled to the processor 702 and to one or more antennae 710 and configured to send and receive cellular communications over one or more wireless networks. The one or more cellular network transceivers 708 and antennae 710 may be used with the above-mentioned circuitry to implement the various aspects and embodiments described herein (e.g., to transmit outgoing messages on an uplink and/or receive incoming messages on a downlink). In various embodiments, the mobile device 700 may also include one or more subscriber identity module (SIM) cards 716, which may be coupled to the cellular network transceiver(s) 708 and/or the processor 702. The mobile device 700 may include a cellular network wireless modem chip 728 (e.g., a baseband processor), which may enable communication via a cellular network and be coupled to the processor 702.

In various embodiments, the mobile device 700 may include a peripheral device connection interface 718 coupled to the processor 702. The peripheral device connection interface 718 may be singularly configured to accept one type of connection, or multiply configured to accept various types of physical and communication connections, common or proprietary, such as USB, FireWire, Thunderbolt, or PCIe. The peripheral device connection interface 718 may also be coupled to a similarly configured peripheral device connection port (not explicitly shown in FIG. 7).

In various embodiments, the mobile device 700 may also include one or more speakers 714 to provide audio outputs and a screen-facing camera 730 to capture image and/or video inputs. The mobile device 700 may also include a housing 720, which may be constructed of a plastic, metal, or a combination of materials, to contain all or one or more of the components discussed herein. The mobile device 700 may include a power source 722 coupled to the processor 702, such as a disposable or rechargeable battery. The power source 722 may also be coupled to the peripheral device connection port to receive a charging current from a source external to the mobile device 700. The mobile device 700 may also include a physical button 724 configured to receive user inputs and a power button 726 configured to turn the mobile device 700 on and off.

According to various aspects, FIG. 8 illustrates another exemplary wireless device 800 that may have a user interface configured to hide or display incoming messages and/or notifications in accordance with the various aspects and embodiments described herein. Although the wireless device 800 is shown in FIG. 8 as having a tablet configuration, those skilled in the art will appreciate that the wireless device 800 may take other suitable forms (e.g., a smartphone). As shown in FIG. 8, the wireless device 800 may include a processor 802 coupled to internal memories 804 and 816, which may be volatile or non-volatile memories, and may also be secure and/or encrypted memories, unsecure and/or unencrypted memories, and/or any suitable combination thereof. In various embodiments, the processor 802 may also be coupled to a display 806, such as a resistive-sensing touchscreen display, a capacitive-sensing infrared sensing touchscreen display, or the like. However, those skilled in the art will appreciate that the display 806 need not have touchscreen capabilities. Additionally, the wireless device 800 may have one or more antenna 808 that can be used to send and receive electromagnetic radiation that may be connected to a wireless data link and/or a cellular telephone transceiver 810 coupled to the processor 802. The wireless device 800 may also include physical buttons 812a and 812b configured to receive user inputs and a power button 818 configured to turn the wireless device 800 on and off. The wireless device 800 may also include, among other components, a microphone (not explicitly shown), a screen-facing camera 814, a battery 820 coupled to the processor 802, and a position sensor 822 (e.g., a GPS receiver) coupled to the processor 802.

According to various aspects, FIG. 9 illustrates an exemplary wearable device 900 suitable for use in accordance with the various embodiments described herein. For example, in various embodiments, the wearable device 900 may include a processor 902 coupled to a volatile and/or non-volatile internal memory 904, which may be secure and/or encrypted memories, unsecure and/or unencrypted memories, or any combination thereof. In various embodiments, the processor 902 may also be coupled to an electronic display screen 906, which may be a touchscreen display (e.g., resistive-sensing touchscreen, capacitive-sensing touchscreen, infrared sensing touchscreen, etc.). A touchscreen controller 928 may be coupled to the processor 902 and the electronic display screen 906. The wearable device 900 may include wide area network (WAN) communications circuitry, such as one or more transceivers 914, such as a cellular telephone transceiver or LTE radio module, coupled to an antenna 908 configured to send and receive electromagnetic radiation. The one or more transceivers 914 and antenna 908 may be used to communicate information over a cellular communications network. The wearable device 900 may also include low-power short-range communication circuitry 924, such as a Bluetooth transceiver, coupled to an antenna 926 and to the processor 902. The low-power short-range communication circuitry 924 may be configured to communicate with a compatible transceiver in the mobile device using one or more of Bluetooth®, Wi-Fi, Peanut®, ZigBee®, ANT, or another suitable low-power wireless communication protocol currently available or which may be developed in the future.

In various embodiments, the wearable device 900 may further include a slide sensor 910 and physical buttons 912 configured to receive user inputs. The wearable device 900 may also include a battery 916 coupled to an inductive charging circuit 918, and a coil antenna 920, which may be an inductive coil adapted to enable inductive charging of the battery 916. The battery 916 and inductive charging circuit 918 may be coupled to the processor 902 to enable the wearable device 900 to control inductive charging and generate messages via the coil antenna 920. The wearable device 900 may further include a vibratory motor 922, and various sensors (e.g., gyroscopes, accelerometers, pedometers, thermometers, thermocouples, etc.), all of which may be coupled to the processor 902.

In various embodiments, the wearable device 900 may include a global positioning system receiver 930 coupled to the processor 902 and which supports United States Global Positioning System (GPS) or other global navigation or satellite positioning systems, such as the Russian GLONASS system and the European Galileo System. The wearable device 900 may also include a biological or physiological sensor 932 configured to monitor one or more physiological parameters, such as heart rate, variability in heart rate, breathing rate, arrhythmia of the heart (if any), general rhythm and functioning of the heart, blood pressure, body movements (i.e., physical activity), steps taken (e.g., a pedometer), body position, body temperature, presence and quantity of sweat, oxygenation, etc. Such sensor(s) 932 may be coupled to the processor 902.

In various embodiments, the electrical components of the wearable device 900 may be integrated and coupled together using surface mount technologies in which components are mounted or placed directly onto the surface of a printed circuit board 934, on a conventional circuit board 934 with through-board connections, multi-chip modules, system on chips (SoC), or any other electrical component mounting, manufacturing, or electronics technology that is currently known or which may be developed in the future. The electrical components of the wearable device 900 may be integrated within a package encompassed by a bezel 940 surrounding the electronic display screen 906 that is coupled to a wrist band 942 so that a user can wear the wearable device 900 like an ordinary watch.

According to various aspects, FIG. 10 illustrates another exemplary personal computing device 1000 that may have a user interface configured to hide or display incoming messages and/or notifications in accordance with the various aspects and embodiments described herein. Although the personal computing device 1000 is shown in FIG. 10 as a laptop computer, those skilled in the art will appreciate that the personal computing device 1000 may take other suitable forms (e.g., a desktop computer). In various embodiments, the personal computing device 1000 shown in FIG. 10 may comprise a touchpad 1022 having a surface that may serve as a pointing device, which may therefore receive drag, scroll, and flick gestures similar to those implemented on mobile computing devices typically equipped with a touchscreen display as described above. The personal computing device 1000 may further include a processor 1012 coupled to a volatile memory 1014 and a large capacity nonvolatile memory, such as a disk drive 1016 of Flash memory. The personal computing device 1000 may also include a floppy disc drive 1018 and a compact disc (CD) drive 1020 coupled to the processor 1012.

The personal computing device 1000 may also include various connector ports coupled to the processor 1012 to establish data connections or receive external memory devices, such as USB connector sockets, FireWire® connector sockets, and/or any other suitable network connection circuits that can couple the processor 1012 to a network. In a notebook configuration, the personal computing device 1000 may have a housing that includes the touchpad 1022, a keyboard 1024, a display 1026, and a screen-facing camera 1028 coupled to the processor 1012. Furthermore, although not separately illustrated in FIG. 10, the personal computing device 1000 may also include a microphone, a battery, and a position sensor (e.g., a GPS receiver) coupled to the processor 1012. Additionally, the personal computing device 1000 may have one or more antenna that can be used to send and receive electromagnetic radiation that may be connected to a wireless data link and/or a cellular telephone transceiver coupled to the processor 1012. Other configurations of the personal computing device 1000 may include a computer mouse or trackball coupled to the processor 1012 (e.g., via a USB input) as are well known, which may also be used in conjunction with the various aspects and embodiments described herein.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the various aspects and embodiments described herein.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The methods, sequences, and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of non-transitory computer-readable medium known in the art. An exemplary non-transitory computer-readable medium may be coupled to the processor such that the processor can read information from, and write information to, the non-transitory computer-readable medium. In the alternative, the non-transitory computer-readable medium may be integral to the processor. The processor and the non-transitory computer-readable medium may reside in an ASIC. The ASIC may reside in an IoT device. In the alternative, the processor and the non-transitory computer-readable medium may be discrete components in a user terminal.

In one or more exemplary aspects, the functions described herein may be implemented in hardware, software, firmware, or any combination thereof. If implemented in software, the functions may be stored on or transmitted over as one or more instructions or code on a non-transitory computer-readable medium. Computer-readable media may include storage media and/or communication media including any non-transitory medium that may facilitate transferring a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of a medium. The term disk and disc, which may be used interchangeably herein, includes CD, laser disc, optical disc, DVD, floppy disk, and Blu-ray discs, which usually reproduce data magnetically and/or optically with lasers. Combinations of the above should also be included within the scope of computer-readable media.

While the foregoing disclosure shows illustrative aspects and embodiments, those skilled in the art will appreciate that various changes and modifications could be made herein without departing from the scope of the disclosure as defined by the appended claims. Furthermore, in accordance with the various illustrative aspects and embodiments described herein, those skilled in the art will appreciate that the functions, steps, and/or actions in any methods described above and/or recited in any method claims appended hereto need not be performed in any particular order. Further still, to the extent that any elements are described above or recited in the appended claims in a singular form, those skilled in the art will appreciate that singular form(s) contemplate the plural as well unless limitation to the singular form(s) is explicitly stated.

1. A method for displaying incoming message notifications, comprising:
receiving an incoming message at a user equipment (UE);
determining, at the UE, whether the incoming message is secured or unsecured based at least in part on a sender identifier;
displaying, at the UE, a notification regarding the incoming message on a user interface, wherein the notification hides content of the incoming message in response to determining that the incoming message is secured; and
displaying, at the UE, the hidden content of the incoming message on the user interface in response to an authentic biometric input having a focus on the displayed notification.

2. The method recited in claim 1, wherein the authentic biometric input is a user fingerprint focused on the notification regarding the incoming message in combination with a fingerprint recognition that matches an authorized user.

3. The method recited in claim 1, wherein the authentic biometric input is a user gaze focused on the notification regarding the incoming message in combination with an iris recognition that matches an authorized user.

4. The method recited in claim 1, wherein the authentic biometric input is a user gaze focused on the notification regarding the incoming message in combination with a facial recognition that matches an authorized user.

5. The method recited in claim 1, further comprising determining, at the UE, that the incoming message is secured based at least in part on the sender identifier having a structure or format associated with an institutional sender.

6. The method recited in claim 1, further comprising determining, at the UE, that the incoming message is secured based at least in part on the content of the incoming message including one or more sensitive terms.

7. The method recited in claim 1, further comprising determining, at the UE, that the incoming message is secured based at least in part on the sender identifier appearing in a user-defined secured sender list.

8. The method recited in claim 1, further comprising determining, at the UE, that the incoming message is unsecured based at least in part on the sender identifier appearing in a user-defined unsecured sender list.

9. The method recited in claim 1, wherein the notification shows the content of the incoming message in response to determining that the incoming message is unsecured.

10. The method recited in claim 1, wherein the incoming message is received while the UE is in a locked state and wherein the user interface is a lock screen.

11. An apparatus, comprising:
a display device;
a receiver configured to receive an incoming message; and
one or more processors configured to determine whether the incoming message is secured or unsecured based at least in part on a sender identifier, to display, via the display device, a notification regarding the incoming message on a user interface, wherein the notification is configured to hide content of the incoming message in response to a determination that the incoming message is secured, and to display, via the display device, the hidden content of the incoming message on the user interface in response to an authentic biometric input having a focus on the displayed notification.

12. The apparatus recited in claim 11, wherein the authentic biometric input is a user fingerprint focused on the notification regarding the incoming message in combination with a fingerprint recognition that matches an authorized user.

13. The apparatus recited in claim 11, wherein the authentic biometric input is a user gaze focused on the notification regarding the incoming message in combination with an iris recognition that matches an authorized user.

14. The apparatus recited in claim 11, wherein the authentic biometric input is a user gaze focused on the notification regarding the incoming message in combination with a facial recognition that matches an authorized user.

15. The apparatus recited in claim 11, wherein the one or more processors are further configured to determine that the incoming message is secured based at least in part on the sender identifier having a structure or format associated with an institutional sender.

16. The apparatus recited in claim 11, wherein the one or more processors are further configured to determine that the incoming message is secured based at least in part on the content of the incoming message including one or more sensitive terms.

17. The apparatus recited in claim 11, wherein the one or more processors are further configured to determine that the incoming message is secured based at least in part on the sender identifier appearing in a user-defined secured sender list.

18. The apparatus recited in claim 11, wherein the one or more processors are further configured to determine that the incoming message is unsecured based at least in part on the sender identifier appearing in a user-defined unsecured sender list.

19. The apparatus recited in claim 11, wherein the notification is configured to show the content of the incoming message in response to a determination that the incoming message is unsecured.

20. The apparatus recited in claim 11, wherein the incoming message is received while the apparatus is in a locked state and wherein the user interface is a lock screen.

21. An apparatus, comprising:
means for receiving an incoming message;
means for determining whether the incoming message is secured or unsecured based at least in part on a sender identifier;
means for displaying a notification regarding the incoming message on a user interface, wherein the notification is configured to hide content of the incoming message in response to a determination that the incoming message is secured; and
means for displaying the hidden content of the incoming message on the user interface in response to an authentic biometric input having a focus on the displayed notification.

22. The apparatus recited in claim 21, wherein the authentic biometric input is a user fingerprint focused on the notification regarding the incoming message in combination with a fingerprint recognition that matches an authorized user.

23. The apparatus recited in claim 21, wherein the authentic biometric input is a user gaze focused on the notification regarding the incoming message in combination with one or more of an iris recognition or a facial recognition that matches an authorized user.

24. The apparatus recited in claim 21, further comprising means for determining that the incoming message is secured based at least in part on the sender identifier having a structure or format associated with an institutional sender or appearing in a user-defined secured sender list.

25. The apparatus recited in claim 21, further comprising means for determining that the incoming message is secured based at least in part on the content of the incoming message including one or more sensitive terms.

26. The apparatus recited in claim 21, wherein the incoming message is received while the apparatus is in a locked state and wherein the user interface is a lock screen.

27. A non-transitory computer-readable storage medium storing computer-executable instructions, the computer-executable instructions configured to cause a device having one or more processors to:
receive an incoming message;
determine whether the incoming message is secured or unsecured based at least in part on a sender identifier;
display a notification regarding the incoming message on a user interface, wherein the notification is configured to hide content of the incoming message in response to a determination that the incoming message is secured; and
display the hidden content of the incoming message on the user interface in response to an authentic biometric input having a focus on the displayed notification.

28. The non-transitory computer-readable storage medium recited in claim 27, wherein the authentic biometric input is a user fingerprint focused on the notification regarding the incoming message in combination with a fingerprint recognition that matches an authorized user.

29. The non-transitory computer-readable storage medium recited in claim 27, wherein the authentic biometric input is a user gaze focused on the notification regarding the incoming message in combination with one or more of an iris recognition or a facial recognition that matches an authorized user.

30. The non-transitory computer-readable storage medium recited in claim 27, the computer-executable instructions further configured to cause the one or more processors to determine that the incoming message is secured based at least in part on the sender identifier having a structure or format associated with an institutional sender or appearing in a user-defined secured sender list.

31. The non-transitory computer-readable storage medium recited in claim 27, the computer-executable instructions further configured to cause the one or more processors to determine that the incoming message is secured based at least in part on the content of the incoming message including one or more sensitive terms.

32. The non-transitory computer-readable storage medium recited in claim 27, wherein the incoming message is received while the device is in a locked state and wherein the user interface is a lock screen.
